(19) United States
(12) Patent Application Publication
(10) Pub. No.: US 2005/0100047 A1
(43) Pub. Date: May 12, 2005

(54) Method of reducing media relay of a network address translation apparatus

(75) Inventors: Chung-Fan Liu, Taipei City (TW); Zeng-Yuan Yang, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei (TW)

(21) Appl. No.: 10/847,402

(22) Filed: May 18, 2004

(30) Foreign Application Priority Data
Nov. 10, 2003 (TW) 092131408

(51) Int. Cl. H04J 3/16

(52) U.S. Cl. 370/466; 370/389

(57) ABSTRACT

A method of reducing media relay of a network address translation (NAT) apparatus involves detecting a network type of a user agent (such as a network address port translator) to determine whether the user agent is a symmetric network type; if it is, a transmitting server is still required to relay a media stream; if it is not, a SIP standard structure and its communication protocol are utilized for changing a network address and its connecting port of an ‘invite’ packet via a proxy server so that the caller and the callee will send the media stream according to the changed network address and its connecting port.

### BACKGROUND OF THE INVENTION

1. Field of the Invention

The present invention relates to a network media transmission technique, and more particularly, to a method of reducing media relay of a network address translation (NAT) apparatus.

2. Description of the Related Art

With developments in the field of networking technology, the voice over IP (VoIP) technique is gaining importance due to the relatively low costs associated with web-based telephone services. Web-based telephone services have the potential to replace traditional telephone services. On the Internet, connection to a terminal device is provided through a distributed IP address. However, there are a limited number of public IP addresses. Consequently, a network address translation (NAT) technique has been developed to solve this problem. Many computer devices therefore utilize a NAT apparatus to connect to the Internet. In other words, these computer devices individually have a private IP address internally, and the NAT apparatus uses a public IP address to connect externally with the Internet.

Due to requirements imposed by the NAT apparatus for external connectivity, these computer devices utilize the private IP address to perform communications over a VoIP connection, and this connection fails in the networking communications environment. This failure occurs because the computer device cannot establish a real time protocol connection utilizing the private IP address. A current solution to this problem involves utilizing a TURN technique. As shown in FIG. 1, a practical environment of such a technique includes a TURN secondary end 11, a NAT apparatus 12, a TURN server 13 and a remote communication apparatus 14. The associated method includes utilizing the TURN server 13 with an external communication means to detect classification of the NAT apparatus 12, where the TURN secondary end 11 is located, and relaying a media stream according to the classification of the NAT apparatus 12. For example, if the classification of the NAT apparatus 12 is restricted cone, port restricted cone or symmetric, the NAT apparatus 12 will need to utilize the TURN server 13 to enable communications, which will increase the loading of the TURN server 13. Furthermore, since an additional communications protocol is required, the complexity of the TURN secondary end 11 and its related program code is increased. Moreover, this technique is not compatible with the existing standard for an SIP user agent.

Therefore, it is desirable to provide a method of reducing media relay of a network address translation (NAT) apparatus to mitigate and/or obviate the aforementioned problems.

### SUMMARY OF THE INVENTION

A main objective of the present invention is to provide a method of reducing media relay of a network address translation (NAT) apparatus, which is compatible with the standard SIP and which substantially reduces the loading of a transmitting server, while reducing unnecessary communications protocols.

In order to achieve the above-mentioned objective, the method of reducing media relay of a network address translation (NAT) apparatus of the present invention is used for a caller and a callee, a first network address port translator, a second network address port translator and a proxy server existing between the caller and the callee for providing a connection. The method includes: (A) determining whether a network type of the first network address port translator and the second network address port translator are symmetric; (B) changing an address port of a packet via the proxy server during an invitation link so that the caller and the callee send the packet to a new address port; and (C) relaying a media stream between the caller and the callee according to the changed address port.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a prior art TURN technique.

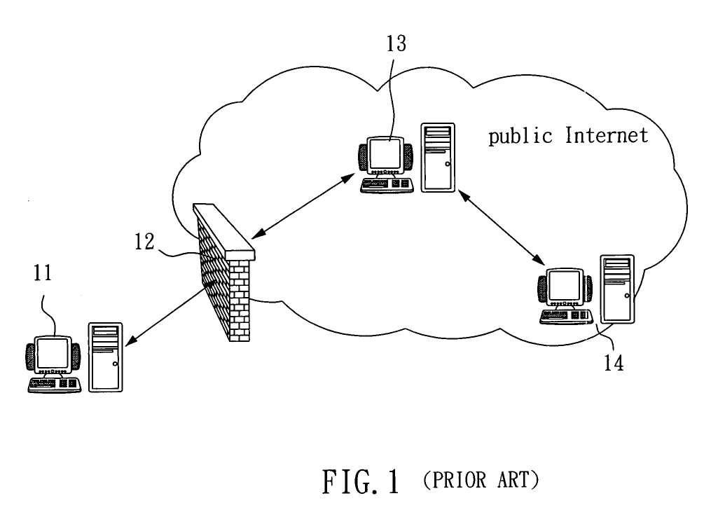

FIG. 2 is a message flowchart of a first embodiment according to the present invention.

FIG. 3 is a message flowchart of a second embodiment according to the present invention.

### DETAILED DESCRIPTION OF THE PREFERRED EMBODIMENT

According to a method of the present invention, the network type of a user agent (such as a network address port translator, which is abbreviated as NAPT) is detected to determine whether the user agent is a symmetric network type; if it is, a transmitting server is still required to relay a media stream; if it is not, the following two embodiments can be utilized for relaying the media stream to reduce relaying frequencies. The following embodiments employ a SIP standard structure and its related communications protocol to change a section of an invitation process, and records related messages.

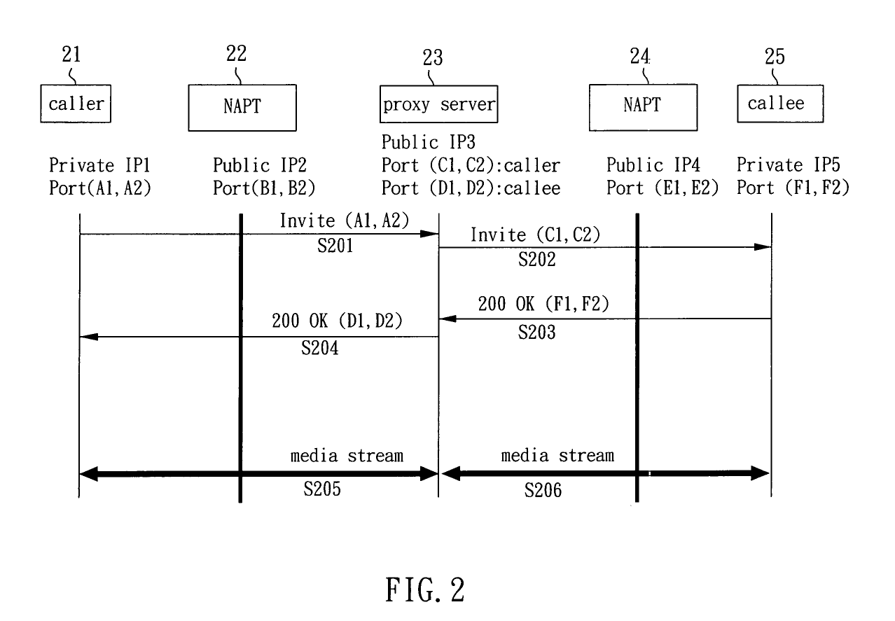

Please refer to FIG. 2. FIG. 2 is a message flowchart of a first embodiment according to the present invention. A caller 21 and a callee 25 perform a media stream relay via network address port translators 22, 24 and a proxy server 23. The caller 21 sends an ‘invite’ packet to the proxy server 23, wherein the ‘invite’ packet comprises a network address A1 of the caller 21 and a connecting port A2 (step 201).

Next, the proxy server 23 changes the private network address A1 and the connecting port A2 in the ‘invite’ packet sent by the caller 21 to a public network address C1 and a connecting port C2 of the proxy server 23, and then sends this changed ‘invite’ packet to the callee 25 (step 202). After receiving the ‘invite’ packet, the callee 25 replies with a 200 OK reply message back to the proxy server 23, and sets its private network address F1 and a connecting port F2 in the appropriate fields of the reply message (step 203).

The proxy server 23 changes the private network address F1 and the connecting port F2 included in the 200 OK reply message sent by the callee 25 to its public network address D1 and a connecting port D2, wherein the public network address D1 is identical to the public network address C1. Afterwards, the proxy server 23 sends the changed 200 OK reply message to the caller 21 to complete an ‘invite’ process (step 204).

The caller 21 and the callee 25 respectively send a media stream to the public network address and the connecting port (C1,C2) and (D1,D2) of the proxy server 23 (step 205 and 206), and the proxy server 23 records a public network address B1 and a connecting port B2 of the network address port translator 22 of the caller 21, and a public network address E1 and a connecting port E2 of network address port translator 24 of the callee 25 after receiving the media stream sent by the caller 21 and the callee 25, to establish a corresponding relationship. Therefore, further media streams can be sent directly without passing through a transmitting server (not shown), which reduces relay frequencies to lighten the transmitting server's load.

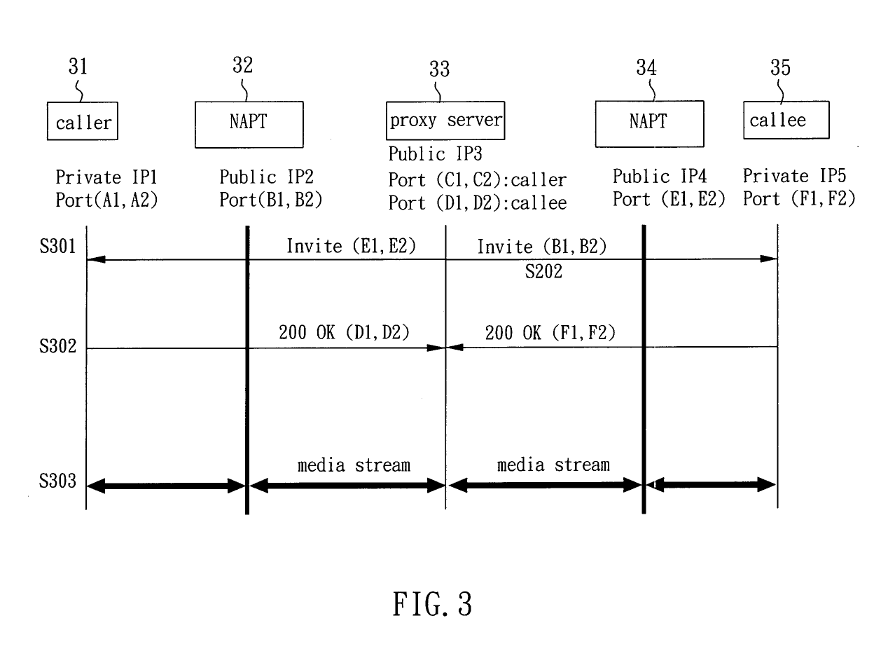

Please refer to FIG. 3. FIG. 3 is a message flowchart of a second embodiment according to the present invention. A caller 31 and a callee 35 perform a media stream relay via network address port translators 32, 34 and a proxy server 33. In this embodiment, the proxy server 33 actively sends an ‘invite’ packet to the caller 31 and the callee 35, and sets a public network address E1 and a connecting port E2 of the network address port translator 34 in the ‘invite’ packet that will be sent to the caller 31, and sets a public network address B1 and a connecting port B2 of the network address port translator 32 in the ‘invite’ packet that will be sent to the callee 35 (step 301).

Next, the caller 31 and the callee 35 respectively reply with a 200 OK reply message to the proxy server 33 to indicate that they have received the ‘invite’ packet (step 302). Afterwards, the caller 31 sends a media stream to the public network address E1 and the connecting port E2 of the network address port translator 34, and the callee 35 sends a media stream to the public network address B1 and the connecting port B2 of the network address port translator 32, which reduces relay frequencies to lighten the transmitting server's load (step 303).

Although the present invention has been explained in relation to its preferred embodiment, it is to be understood that many other possible modifications and variations can be made without departing from the spirit and scope of the invention as hereinafter claimed.

1. A method of reducing media relay of a network address translation apparatus for a caller and a callee, a first network address port translator, a second network address port translator and a proxy server existing between the caller and the callee for providing a connection, the method comprising:
(A) determining whether a network type of the first network address port translator and the second network address port translator are symmetric;
(B) changing an address port of a packet via the proxy server during an invitation link so that the caller and the callee send the packet to a new address port; and
(C) relaying a media stream between the caller and the callee according to the changed address port.

2. The method as claimed in claim 1, wherein the caller has a first network address, the first network address port translator has a second network address, the proxy server has a third network address, the second network address port translator has a fourth network address, the callee has a fifth network address, the caller has a first connecting port, the first network address port translator has a second connecting port, the proxy server has a third connecting port and a fourth connecting port, the second network address port translator has a fifth connecting port, and the callee has a sixth connecting port.

3. The method as claimed in claim 2, wherein the proxy server utilizes the third network address, the third connecting port and the fourth connecting port to change the first network address and the first connecting port included in the packet sent by the caller, and changes the fifth network address and the sixth connecting port included in a reply packet sent from the callee, so that the caller sends the media stream to the third connecting port of the proxy server, and the callee sends the media stream to the fourth connecting port of the proxy server to build a corresponding relationship to transmit the media stream to the caller and the callee according to the relationship.

4. The method as claimed in claim 2, wherein the proxy server first sends out a first invitation link packet and a second invitation link packet to the caller and the callee respectively, the first invitation link packet having the fourth network address and the fifth connecting port, the second invitation link packet having the second network address and the second connecting port, so that the caller uses the fourth network address and the fifth connecting port to send out the media stream, and the callee uses the second network address and the second connecting port to send out the media stream.

5. The method as claimed in claim 1, wherein in step (A), if the first network address port translator and the second address port translator are a symmetric network type, the first network address port translator and the second address port translator utilize a delivery server to perform the media relay.

6. The method as claimed in claim 1, wherein in step (B) and step (C), a SIP standard structure and related communications protocol is employed.
